(19) United States
(12) Patent Application Publication
(10) Pub. No.: US 2021/0257115 A1
(43) Pub. Date: Aug. 19, 2021

(54) The Use of a Stirling Engine to Provide Emergency Heat Removal to the Containment Environment of a Nuclear Reactor Building

(71) Applicants: Robert Emery Becse, Export, PA (US); Francis Paul Ferraraccio, Southwick, MA (US); William Edward Densmore, Pittsburgh, PA (US)

(72) Inventors: Robert Emery Becse, Export, PA (US); Francis Paul Ferraraccio, Southwick, MA (US); William Edward Densmore, Pittsburgh, PA (US)

(21) Appl. No.: 16/873,164

(22) Filed: Feb. 18, 2020

(51) Int. Cl. G21C 15/18; G21D 3/06

(52) U.S. Cl. CPC G21C 15/18; F02G 2254/90; G21D 3/06

(57) ABSTRACT

A Stirling engine provides a means to use the thermal energy in the sealed containment environment of a nuclear reactor building to provide emergency cooling. Acting as the prime mover in a coupled heat exchanger system, a Stirling engine could develop fluid flow thereby resulting in forced convection vice natural circulation and would not rely on an external power source during an unusual accident event where no electric power is available.

### BACKGROUND

During an emergency at a nuclear power plant, containment fan cooling units are used to provide cooling to the isolated containment environment. The fan cooling units use forced convection that is provided by an electrically powered motor. The fans provide forced air flow to a heat exchanger. This heat exchanger facilitates the exchange of heat from the hot containment environment to a secondary, cool fluid that is brought inside containment. In the case where the event involves a loss of all electric power, these motors would not function and there would be no means to cool the containment environment aside from a minimal amount of cooling from natural circulation.

Additionally, in the event of a natural catastrophe, fuel sources that power emergency diesel generators (EDG) could be compromised and access to the nuclear site may be compromised. As such, it is possible that the fuel to power the EDGs would not be available.

A Stirling engine that uses the hot containment environment as a heat source could convert this thermal energy to mechanical energy to power fluid flow without the use of an electric motor. The secondary fluid would be used as a heat sink for the Stirling engine. It is envisioned that the Stirling engine would power a fan and establish forced convection on the hot side of the heat exchanger. Likewise, the cold fluid could be circulated by having a pump powered by a second Stirling engine.

In this arrangement, fluid flow would be initiated by natural circulation and then transition to forced convection through the use of a Stirling engine. The thermal energy contained within the sealed, containment environment would continue to be dissipated until the thermal gradient was no longer a concern for the integrity of the containment building.

This arrangement offers the following benefits:
1. It does not rely on electricity to provide a means to cool the nuclear reactor containment environment.
2. In the event of a natural catastrophe that would prevent access to the nuclear site, it would not require that fuel be brought in to support this system
3. It offers greater cooling capacity then simply relying on natural circulation.
4. It will remain in operation as long as there is a thermal gradient to drive the process. As a result, the process is self-controlling.

### SUMMARY

The arrangement would use a Stirling engine to provide an assured means to support the function of a heat exchanger as the primary means to transfer thermal energy out of an isolated containment environment of a nuclear power plant. The Stirling engine will drive fluid flow through the heat exchanger. The Stirling engine would be used as a prime mover to provide fluid flow to primary fluid and could also be used as a prime mover to provide fluid flow to the secondary fluid. The Stirling engine would take the thermal energy associated with the hot containment environment and convert it to mechanical energy to drive fluid flow. In this manner, the paired use of the heat exchanger with the use of a Stirling engine would aid in the dissipation of energy within the sealed containment environment.

### DETAILED DESCRIPTION

The invention consists of the use of an air-to-fluid heat exchanger, a fan powered by a Stirling engine, piping containing the secondary fluid, isolation valves for secondary fluid, and a pump power by a Stirling engine.

The air-to-fluid heat exchanger is envisioned to be a tube-to-fin heat exchanger but other air-to-fluid heat exchanger designs could be adapted for this purpose. The air-to-fluid heat exchanger would be located in the sealed containment environment. Cool liquid from outside containment would flow through the tubed portion of the heat exchanger while the hot containment environment would transfer heat to the finned portion of the heat exchanger. This thermal energy would then be transferred to the tubed portion of the heat exchanger and ultimately transferred to the cool secondary fluid and thus remove the heat from the containment environment.

In order to promote the flow of air within the containment environment, a Stirling engine connected to a fan would be used. The hot containment environment would provide the hot temperature source to drive the Stirling engine. The secondary fluid could be used as the heat sink for the Stirling engine. Using this difference in temperature to power the Stirling engine, the Stirling engine would be used to drive a fan. This fan would then establish air flow over the finned portion of the heat exchanger. Additionally, using the same temperature difference, a Stirling engine could be connected to a pump to establish flow in the cool secondary loop. The Stirling engine(s) would be located inside the sealed containment environment.

Piping and isolation valves would be used to conduct the secondary fluid to and from the containment environment. The piping and valves would provide a barrier between the outside environment and the sealed containment environment. While the piping would penetrate the sealed containment, it would not allow the secondary fluid to mix with the containment environment. As such, the containment environment would remain sealed.

In the normal mode of operation of a nuclear power plant this system would not be in operation. The valves with the secondary fluid would be closed. As such, there would be no heat transfer as all of the components of this system within containment would be at essentially a uniform temperature.

In the event of a severe emergency where substantial heat is generated in the sealed containment environment, the isolation valves of the secondary fluid would be opened. The secondary fluid would then be permitted to enter the piping. The tube side of the heat exchanger would be connected to this piping. As such, the secondary fluid would then flow through the tubed portion of the heat exchanger. With the secondary fluid flowing in the tubed side of the heat exchanger located in containment a thermal gradient would be developed. The Stirling engine(s) within the sealed containment would then be provided with the energy to circulate air within the containment environment and within the secondary fluid. With this thermal gradient to power the Stirling engines, flow greater than simply natural circulation could be established and remove the energy from the sealed containment environment. It is noted that in addition to the removal of thermal energy by the heat exchanger, by the very nature of the Stirling engine, it too would assist in the removal of this thermal energy by the conversion of heat to work in providing the motive force for the fan and pump. This system would continue to operate until a thermal gradient no longer existed that was sufficient to power the Stirling engines.

### DRAWING DESCRIPTION

FIG. 1 identifies the general layout of the heat removal system which utilizes a fan powered by the Stirling engine to develop forced convection cooling of the hot containment environment.

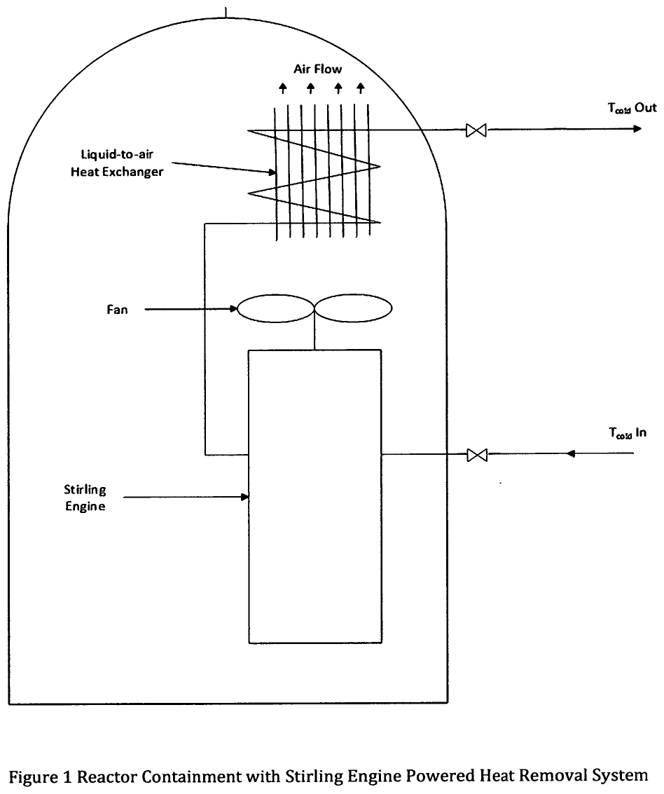

1. The claim herein is the novel use of a system that utilizes a Stirling engine to provide the motive driver to a fan to provide forced convection cooling of a hot containment environment which does not rely on an external electrical power source, promotes improved heat transfer over natural convection, and is self-regulated by the thermal conditions in the containment environment.
